(19) United States
(12) Patent Application Publication
(10) Pub. No.: US 2008/0187881 A1
(43) Pub. Date: Aug. 7, 2008

(54) Matrix Device

(76) Inventor: Harald Rus, Steinach (AT)

Correspondence Address: BROOKS KUSHMAN P.C., 1000 TOWN CENTER, TWENTY-SECOND FLOOR, SOUTHFIELD, MI, 48075, US

(21) Appl. No.: 11/816,474

(22) PCT Filed: Feb. 4, 2006
(86) PCT No.: PCT/EP06/00979

§ 371 Date: Aug. 16, 2007

(30) Foreign Application Priority Data
Feb. 17, 2005 (AT) A 261/2005
Oct. 27, 2005 (AT) A 1757/2005

(51) Int. Cl. A61C 5/04

(52) U.S. Cl. 433/39

(57) ABSTRACT

The invention relates to a matrix device (1) for tooth treatments comprising a matrix (2) and at least one wedge (3), wherein said matrix (2) is made of a flexible material and is or can be connectable to said solid and reversibly deformable wedge (3) in such a way that they are embodied in the form of one single component.

The invention relates to a matrix device for dental treatments, comprising a matrix and at least one wedge.

The previously known matrix devices for the processing of composite in the patient's mouth all have the common feature, irrespective of the form they otherwise take, of making no allowance for the material to be processed in the mouth. The matrices consist either of a solid material, usually metal, or of a soft, flexible plastic.

The solid matrices are only suitable for the processing of condensable material and the soft matrices, while allowing processing of non-condensable material such as composite, can only be brought into the interdental space with difficulty, or not at all. A soft matrix is required because non-condensable materials are modelled from the inside out against the matrix, the flexible matrix yielding and allowing a convex forming of the material to be modelled. This makes it possible to restore the treated tooth in such a way that a secure contact point with the neighboring tooth is formed, and this is adequately supported.

Additional anchoring of the matrix in the interdental region with wedges is always necessary to achieve a seal with respect to the interdental region. The wedges used for this do not make any allowance for the depth of the prepared cavity and height of the papilla. Consequently, they often do not allow good sealing of the preparation with respect to the moist environment in the oral cavity, which leads to problems in particular when processing composite, since a relative dryness is necessary here during the processing.

The object of the invention is to provide a matrix device which makes it possible for a soft, flexible matrix, as required for the processing of non-condensable materials, to be introduced easily into the interdental space, and to fix this matrix in only one working step by means of an associated wedge, and in this way ensure reliable sealing with respect to the moist environment of the oral cavity. Furthermore, it is an object of the invention to provide a matrix device with which the wedge is formed in such a way that allowance can be made for individual differences in the anatomy of the interdental space.

This is achieved according to the invention by a matrix made of a soft, flexible material being connected or connectable to a solid, reversibly deformable wedge to form a single component.

One feature of this invention is that the soft, flexible matrix is made of a plastic which is suitable for the processing of non-condensable materials, and that the solid, reversibly deformable wedge is made of a material with a memory effect or a certain elasticity, preferably from titanium. However, the matrix and the wedge may also both be made of the same material, for example of plastic or a solid silicone rubber, and consequently be molded together already during production, or be produced from one part and thereby firmly connected to each other.

A matrix device according to the invention is constructed in such a way that the wedge has on its upper side a slot in which the matrix can be clamped. The advantage of such a matrix device is that both the thin flexible matrix and the fixation wedge can be introduced simultaneously into the interdental space with only one working step for the person carrying out the treatment. If, as in a preferred embodiment of the invention, the wedge is made of titanium and has a slot on the upper side and a fillet on the underside, the flexible matrix can be introduced into the consequently widened slot by pressing the two limbs of the wedge together. As a result of the memory effect or the elasticity of the wedge material, it resumes its original state when it is let go, whereby the matrix is firmly clamped in the slot.

A further feature of the invention is that at least one narrow side of the wedge has a taper, which facilitates the introduction into the interdental space.

According to one feature of the invention, the matrix is a plastic strip which has at the lower edge a tab that can be clamped in the wedge, the lower edge and the tab being made thicker, and therefore less flexible, and the upper edge of the matrix being made thinner, and therefore more flexible, the thickness of the matrix being made such that it decreases from the lower edge toward the upper edge. On account of the thicker lower edge and tab of the matrix, a non-positive, secure clamping connection is produced when the wedge is introduced. Furthermore, it is ensured by the upwardly progressing decrease in thickness of the matrix that the matrix device is, on the one hand, stable enough to be pushed into the interdental space and, on the other hand, flexible enough in the vicinity of the prepared cavity to make it possible for a non-condensable material to be processed.

Furthermore, a matrix device according to the invention may be configured in such a way that the matrix comprises two flexible legs respectively at the sides, which converge in a middle part of the matrix and can be clamped into the wedge with a common tab at the lower edge. Such an arrangement makes it possible to treat two neighboring teeth simultaneously with only one matrix device. This has the advantage that other working steps and treatment time can be saved, since it has previously only been possible and necessary to treat each tooth individually.

Instead of a double-Y-shaped matrix with four flexible legs at the sides, it is of course also possible according to the invention for two thin matrices to be clamped both together in a slotted wedge.

According to the invention, the matrix device may also be configured in such a way that the matrix comprises a solid matrix part, preferably of metal, with a soft, flexible matrix part, preferably of plastic, being arranged in a clearance in the matrix. The solid matrix part may in this case be made, for example, of a deformable metal, for example of metal with a high zinc content, which makes it possible to mold the matrix onto the tooth. As a result, additional securing by means of a circlip would no longer be required.

Furthermore, the matrix may also be configured as a solid ring, for example of metal, which can be clamped around a tooth, the wedge in this case being used loosely as a component on its own. This embodiment also has the advantage that the soft, flexible matrix part can be easily introduced into the interdental space and fixed with the aid of a solid matrix part or the metal ring.

In a further embodiment of the invention, the matrix device may be of a circular form, the wedge being arranged along at least part of the circumference of the matrix. Furthermore, the matrix may be formed as a small crib-shaped plate, the wedge being arranged at an arcuate lower edge of the matrix.

Furthermore, the wedge may have on its underside a fillet, which serves for receiving the papilla. In addition to the fillet located on the underside of the wedge, the limbs of the wedge may, according to the invention, be formed with different lengths, it being possible to make allowance for the anatomical differences of individual interdental spaces, and make possible secure sealing of the prepared cavity with respect to the oral cavity.

The corresponding wedge may be advantageously formed such that it increases in its width, height and limb length from a tip, which makes it possible to use a single matrix device for different interdental spacings.

The wedge of increasing thickness, height and limb length is particularly advantageous when the same is arranged on an arcuate matrix, as is the case with the crib-shaped plate or with the circular matrix. In the case of this arrangement, the steepness of the increase of the wedge is less than would be the case with a wedge with a straight upper edge, whereby the wedge with the corresponding matrix can be introduced more easily into the interdental space. A further advantage of a crib-shaped or circular matrix is that, in the case of particularly deep cavities at the edge of the interdental space, the gingiva may be in the way when the matrices are introduced. An appropriate radius on the matrix therefore allows it to achieve the necessary depth at the respective points in order to securely seal the cavity.

As a further feature, additional thickenings, grips or the like may be arranged on the matrix for easier manipulation during the introduction and removal of the matrix.

Further advantageous features are presented in more detail below, in the description, the claims and the drawings.

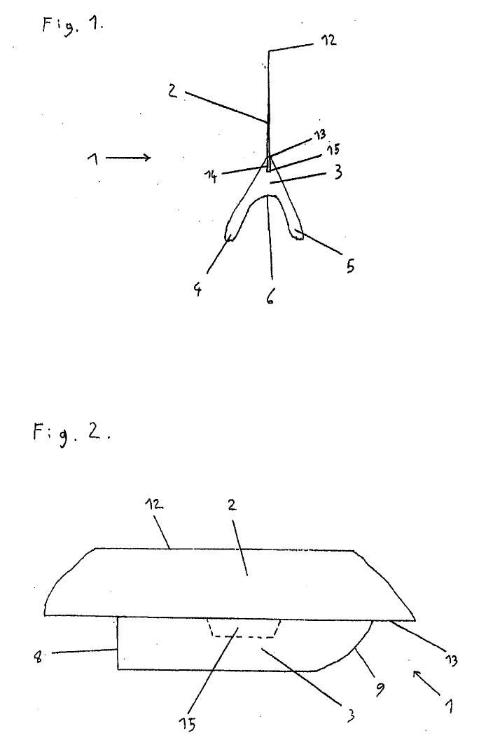

FIG. 1 shows a cross section through a matrix device according to the invention.

FIG. 2 shows a side view of the matrix device according to the invention.

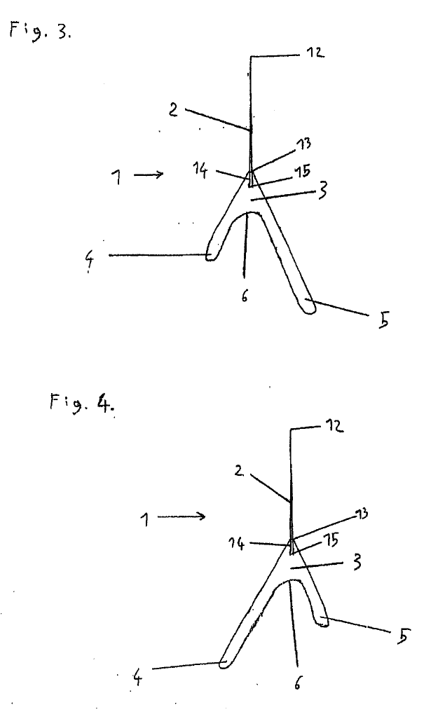

In FIG. 3, a cross section of a matrix device with wedge limbs of different lengths can be seen.

FIG. 4 shows a further embodiment of a matrix device with wedge limbs of different lengths.

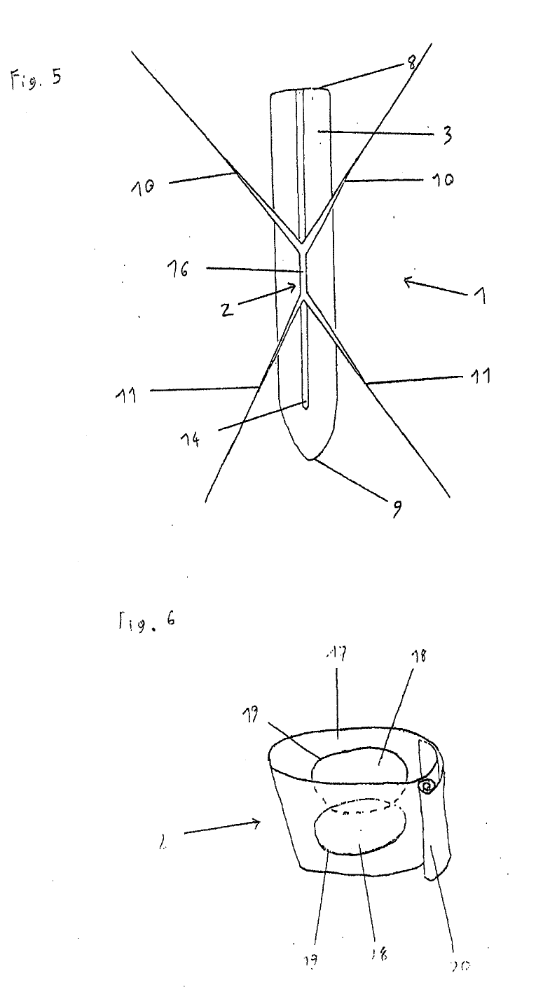

FIG. 5 shows a plan view of a matrix device with a four-legged matrix.

FIG. 6 shows an oblique view of a matrix in the form of a metal ring.

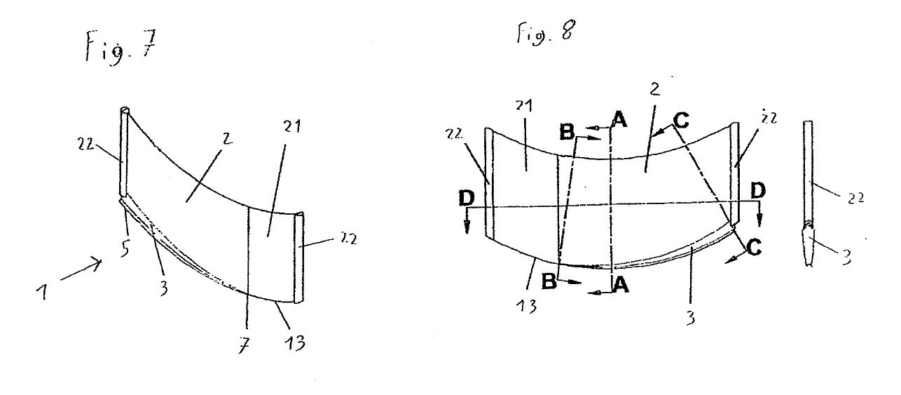

FIG. 7 shows an oblique view of a crib-shaped matrix device.

FIG. 8 shows a plan view of a crib-shaped matrix device according to FIG. 7 with a side view arranged alongside.

FIG. 9 shows a section along the line C-C from FIG. 8.

FIG. 10 shows a section along the line B-B from FIG. 8.

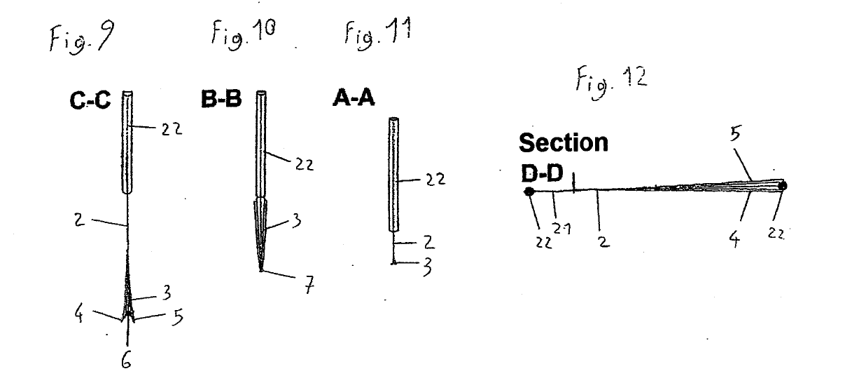

FIG. 11 shows a section along the line A-A from FIG. 8.

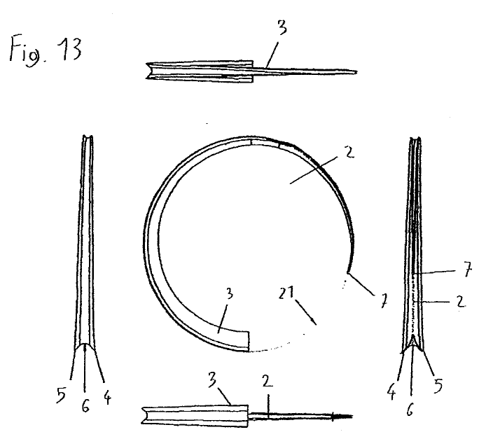

FIG. 12 shows a section along the line D-D from FIG. 8.

FIG. 13 shows a plan view of a circular matrix device with respectively assigned side views.

The matrix device 1 shown in FIG. 1 comprises a matrix 2 and an associated wedge 3. The matrix 2 may be made, for example, of a plastic strip, which can be industrially produced easily and at low cost. The matrix 2 is configured such that it is thin and flexible at the upper edge 12 and becomes thicker toward the lower edge 13 and in the lingual and buccal directions. The wedge 3 has on its upper side a slot 14, in which the matrix 2 is clamped by means of the tab 15. Furthermore, the underside of the wedge is configured as a fillet 6, whereby a left limb 4 and a right limb 5 are formed.

FIG. 2 shows a side view of the matrix device 1, comprising the matrix 2 and the wedge 3. In this embodiment, the wedge 3 is configured such that it is straight on one narrow side 8, and has a taper 9 on the other narrow side, which make it possible to introduce the matrix device 1 into the interdental space more easily. The matrix is clamped into the wedge 3 only by the tab 15, which makes it possible to mold the soft matrix 2 to the tooth and fasten it by means of a circlip, in order to seal the prepared cavity securely on all sides.

FIGS. 3 and 4 respectively show a cross section through a matrix device 1 in which the wedge 3 has limbs 4, 5 of different lengths. In the case of the example of the wedge shown in FIG. 3, the right limb 5 is longer than the left limb 4. The exemplary embodiment shown in FIG. 4 is an exactly mirror-inverted embodiment, in which the left limb 4 is longer than the right limb 5. In principle, it is possible by the use of three different embodiments of wedge forms, as shown in FIGS. 1, 3 and 4, for allowance to be made for most individual differences in the anatomy of the interdental spaces, and for secure sealing of the prepared cavity to be ensured in every treatment.

FIG. 5 shows a plan view of a matrix device 1 with a matrix 2, which has two legs 10, 11 respectively at the sides. The four legs 10, 11 converge in a common middle part 16 of the matrix 2. At the lower edge of the middle part 16 there is the tab 15 with which the matrix 2 is clamped in the slot 14 of the wedge 3. By means of such an arrangement it is possible to treat two neighboring teeth simultaneously, which leads to a considerable time saving.

The oblique view shown in FIG. 6 shows an annular matrix 2, which is formed by a solid matrix part 17, for example of metal, in which a soft matrix part 18, for example of plastic, is arranged in a clearance 19. In the exemplary embodiment shown, two round clearances 19 are provided on each side of the matrix 2. It goes without saying that the clearances 19 may also have any other form. Depending on how the prepared cavity happens to be, the clearance 19 may be of the form that is suitable in the particular case. By attaching a clamp (not shown) and tightening the matrix 2 by means of the tensioning coil 20, the matrix 2 is brought right up against the tooth. In addition, the matrix 2 is also secured in the interdental space by wedges.

FIG. 7 shows an oblique view of a crib-shaped matrix device 1, in which the matrix 2 is provided in the form of a small wedge-shaped plate. At its lower edge 13, a wedge 3 is arranged along the arc. The wedge is formed such that it increases in its width, height and limb length from a tip 7. At one end of the matrix 2 there is a matrix portion 21 that is made thin and serves for introducing into the interdental space. At both lateral ends of the matrix 2 there are reinforcements 22, which facilitate the manipulation of the matrix.

FIGS. 8 to 12 show a plan view and corresponding sectional representations of the crib-shaped matrix device 1 shown in FIG. 7. In the case of the section shown in FIG. 9, the left and right limbs 4, 5 and the fillet 6 of the wedge can likewise be seen. In the case of this embodiment, the limbs 4, 5 are formed with the same length, but according to the invention they may also be of different lengths, in order to allow for the respective special anatomical features of the various interdental spaces.

FIG. 13 shows a circular matrix device 1 in which the wedge 3 is arranged along the circular circumference of the matrix 2. The wedge is in this case once again formed such that it increases in its width, height and limb length from a tip 7. For introduction into the interdental space, a thin matrix portion 21 is likewise provided. After the introduction of the matrix 2, the wedge 3 is pushed into the interdental space from the tip 7, by turning the device 1, until a wedge thickness that fills the respective interdental space is reached and the cavity is consequently adequately sealed. In the case of the embodiment shown, the limbs 4, 5 are likewise formed with the same length. However, as in the case of all the other embodiments, they may be formed with different lengths according to the anatomical situation.

1. A matrix device for dental treatments, comprising a matrix and at least one wedge, characterized in that a matrix (2) made of a soft, flexible material is connected or connectable to a solid, reversibly deformable wedge (3) to form a single component.

2. The matrix device as claimed in claim 1, characterized in that the soft flexible matrix (2) is made of a plastic, suitable for the processing of non-condensable materials.

3. The matrix device as claimed in claim 1 or 2, characterized in that the solid, reversibly deformable wedge (3) is made of a material with a memory effect or a certain elasticity, preferably of titanium.

4. The matrix device as claimed in one of claims 1 to 3, characterized in that the matrix (2) and the wedge (3) are made of the same material, for example of a solid silicone rubber.

5. The matrix device as claimed in one of claims 1 to 4, characterized in that the wedge (3) has on its upper side a slot (4) in which the matrix (2) can be clamped.

6. The matrix device as claimed in one of claims 1 to 5, characterized in that at least one narrow side (8) of the wedge (3) has a taper (9).

7. The matrix device as claimed in one of claims 1 to 6, characterized in that the matrix (2) is a plastic strip which has at the lower edge (13) a tab (15) that can be clamped in the wedge (3), the lower edge (13) and the tab (15) being made thicker, and therefore less flexible, and the upper edge (12) of the matrix (2) being made thinner, and therefore more flexible, the thickness of the matrix (2) being made such that it decreases from the lower edge toward the upper edge.

8. The matrix device as claimed in one of claims 1 to 7, characterized in that the matrix (2) comprises two flexible legs (10, 11) respectively at the sides, which converge in a middle part (16) of the matrix and can be clamped into the wedge with a common tab (15) at the lower edge (13).

9. The matrix device as claimed in one of claims 1 to 7, wherein two matrices (2) are clamped both together in a slotted wedge (3).

10. The matrix device as claimed in claim 1, characterized in that the matrix (2) comprises a solid matrix part (17), preferably of metal, with a soft, flexible matrix part (18), preferably of plastic, being arranged in a clearance (19) in the matrix (2).

11. The matrix device as claimed in claim 10, characterized in that the matrix (2) is configured as a ring, which can be clamped around a tooth, the wedge (3) being configured loosely as a component on its own.

12. The matrix device as claimed in one of claims 1-4, characterized in that the matrix (2) is of a circular form, the wedge (3) being arranged along at least part of the circumference of the matrix (2).

13. The matrix device as claimed in one of claims 1 to 4, characterized in that the matrix (2) is formed as a small crib-shaped plate, the wedge (3) being arranged at least along a portion at an arcuate lower edge (13) of the matrix (2).

14. The matrix device as claimed in one of claims 1 to 13, characterized in that additional thickenings, grips (22) or the like are arranged on the matrix (2) for easier manipulation.

15. The matrix device as claimed in one of claims 1 to 14, characterized in that the wedge (3) has on its underside a fillet (6) for receiving the papilla.

16. The matrix device as claimed in one of claims 1 to 15, characterized in that the limbs (4, 5) of the wedge (3) are formed with the same or different lengths.

17. The matrix device as claimed in one of claims 1 to 16, characterized in that the wedge (3) is formed such that it increases in its width, height and limb length from a tip (7).
